(19) United States
(12) Patent Application Publication
(10) Pub. No.: US 2013/0103727 A1
(43) Pub. Date: Apr. 25, 2013

(54) Accessible Information System

(71) Applicant: Robert G. Marcotte, New Paltz, NY (US)

(72) Inventor: Robert G. Marcotte, New Paltz, NY (US)

(21) Appl. No.: 13/448,550

(22) Filed: Apr. 17, 2012

Related U.S. Application Data
(60) Provisional application No. 61/476,382, filed on Apr. 18, 2011.

(51) Int. Cl. G06F 17/30

(52) U.S. Cl. CPC G06F 17/30091
USPC 707/827

(57) ABSTRACT

According to the invention, records pertaining to an individual are centralized such that the user has control over the integration and dissemination of their personal and private information. Records pertaining to an individual are systematically transported electronically by many different institutions to a centralized record storage provider wherein the individual user has ownership of and control of their confidential personal information. The systematic accumulation of medical records provides for better overall health tracking and faster and more accurate diagnosis when illness or emergency occurs.

### CROSS-REFERENCES

This application claims the priority of provisional application: 61/476,382 filed on Apr. 4, 2011 by inventor Robert G. Marcotte entitled: “Comprehensive Wellness Tracking System”

### BACKGROUND OF THE INVENTION

1. Field of the Invention

The invention contained herein pertains to the field of networked information systems and in particular to a system for centralizing an individual's personal information such that the individual has ownership of and systematically receives personal information gathered by institutional parties.

2. Description of the Related Art

Medical, financial, civil and retail institutions maintain records for individuals. Record ownership resides with the institutional party. The individual party, to whom these records pertain, is isolated from the information management process and unable to control records within the public domain.

Medical records are distributed across the industry and systematically destroyed. Systematic tracking of health records within families and lifetimes is nonexistent. Public health costs are high due to repetitive testing and a lack of early detection.

Application software, and in particular, office automation systems provide institutions with platforms for managing the operations within the institution and for gathering and maintaining the records of individuals. Cross institutional access to information is limited to nonexistent.

Aspects of financial information related to individuals is routinely transmitted between financial institutions for maintaining credit ratings. Likewise, insurance companies transmit records to civil agencies pertaining to automotive insurance coverage. Insurance companies also systematically receive claims electronically from medical institutions including private practices.

Information transport and storage systems routinely pass information across secure and insecure information networks. File transfer protocol (FTP) provides a method for accessing a remote information storage area across a network, henceforth referred to as an FTP destination. Remote procedure calls (RPC) offer a second protocol for transferring information across networked locations.

Each protocol shall now be described in detail. With FTP, a first party has file ownership rights to an FTP destination. The FTP destination hardware (computers, disk drives, network interfaces) is typically hosted (i.e. physically owned) by a second party. Hosting application software provides the first party with a means for generating usernames and passwords for allowing access to their FTP destination area. Using the host application software, the first party creates an account identifier, i.e. a username and password, and provides the FTP destination and account identifier to a third party. The third party accesses the network location of the first party and, after providing the FTP password, has access to the information storage area. Once the third party moves a file into the first party's information storage area, the first party attains ownership of the file and has full control over the file. That is, the first party can delete, modify, archive, or share the file received.

The FTP protocol is commonly used for website development and for transferring large engineering documents between designers and manufacturers. Application software for website development stores the FTP destination and password within the configuration tables of the website being created. As the developer builds the website, FTP provides a link between the application software and the FTP destination.

RPC's offer a simpler interface between sophisticated websites. With an RPC, a first website can poll a second website for selective information. That is, the first website prepares an information request record, and sends the record to the second website. The second website receives the information request and returns the information requested to the first website as a reply record.

FIG. 1 illustrates the network typology for an electronic mail (email) transport system. Users U1, U2, U3 and U4 each connect to a central email server across a network. The email server receives and stores email messages for each user. Thus, a message transported from user U1 to a User U3 is transmitted from User U1, travels across a network to an email server with whom user U3 has an email account. At the creation of the message, ownership of the message is directed to the recipient. Once the transport begins, the originator no longer has control over the message; the recipient, user U3, bears ownership of the record. User U3 must periodically check the server for messages. Depending upon the email server configuration, messages are either stored indefinitely on the server or are downloaded to user U3 upon request. In either case, the receiving user, i.e. U3 gains full control over the message. User U3 may forward, delete or store the message and any attachments tied thereto. This system allows for information to be passed between users and/or institutions, however institutions do not transmit personal user information to the user.

FIG. 2a illustrates an exemplary network topology for a user U1 with network ties to accounting software Q1 and to financial institutions B1 and B2. Note that accounting software Q1 also ties into financial institutions B1 and B2. Thus, user U1 has access to read and download information retained by, and bearing ownership, of financial institutions B1 and B2 through a user interface for each bank or though accounting software Q1. Financial institutions B1 and B2 have ties to a credit reporting agency C1 where information regarding user U1 is systematically updated. Financial institutions generally do not share users information. The problem with this financial system is that the financial institution bears ownership of the information and user must periodically view or download the information from the financial institutions within a limited period of time before user accessibility is removed. Accounting software Q1 provides an ability for user U1 to download and locally store the information, however, user U1 must initiate the transfer; information is not transferred automatically or systematically. Additionally, the information is not readily transferable and user U1 is solely responsible to maintaining the downloaded information. Such a system also does not address the other information needs of the user.

FIG. 2b shows that user U1 is disconnected from his medical records retained by, and bearing ownership of, doctors D1 and D2. Ownership of medical records resides with the doctor. Doctors D1 and D2 have office automation software (OAS) which provides network ties to pharmacies P1 and insurance companies 11 to address the needs of the doctors. Note too, that there is a disconnect between doctors D1 and D2; restricting the flow of medical information between doctors. Doctor D2 must request a record from doctor D1 which is commonly electronically mailed or sent via electronic facsimile (fax).

Thus the goal of the invention contained herein is to provide a user accessible information system wherein a user's records are readily accessible, portable and owned by the individual.

### SUMMARY OF THE INVENTION

The invention contained herein addresses the aforementioned issues by providing methods for an accessible information system centred on the individual. According to the invention, records pertaining to an individual, (i.e. a user of the system) are centralized such that the user has control over the integration and dissemination of their personal and private information. The invention provides for a system wherein records pertaining to an individual are systematically transported electronically by many different institutions to a centralized record storage provider determined by the user wherein the individual user can access and control the information as needed.

FIG. 3 illustrates a network typology according to aspects of the invention using like numerology as FIGS. 1 and 2. Users U1-U4 each have accounts on, and network access to, a record server wherein their personal records are stored. Institutions including, but not limited to, financial (B1, B2, C1), medical (D1, D2, P1, hospitals H1), insurance companies (I1), travel providers (T1), dentists, laboratories and government agencies each transmit records to the record server systematically, in response to transactions, such that user U1 has access to records regarding his personal affairs subsequent to the transaction.

This system has numerous advantages. With readily accessible records stored in a centrally located database, user U1 may control the dissemination of personal information between service providers. The systematic accumulation of medical records provides for better overall health tracking and faster and more accurate diagnosis when illness or emergency occurs.

### DESCRIPTION OF THE DRAWINGS

FIG. 1 illustrates a prior art network topology for transferring electronic mail (email) between users across an information network.

FIG. 2a illustrates prior art the information links between a user, accounting software, banks and credit reporting agencies.

FIG. 2b illustrates the prior art information links between doctors, pharmacies and insurance companies.

FIG. 3 illustrates an exemplary network topology according to the invention wherein: information records according to users are received from a plurality of institutions and controlled by the users.

FIG. 4 illustrates an exemplary flowchart of the invention detailing the user's control of their personal information.

FIG. 5 illustrates an exemplary information storage and retrieval system according to the invention.

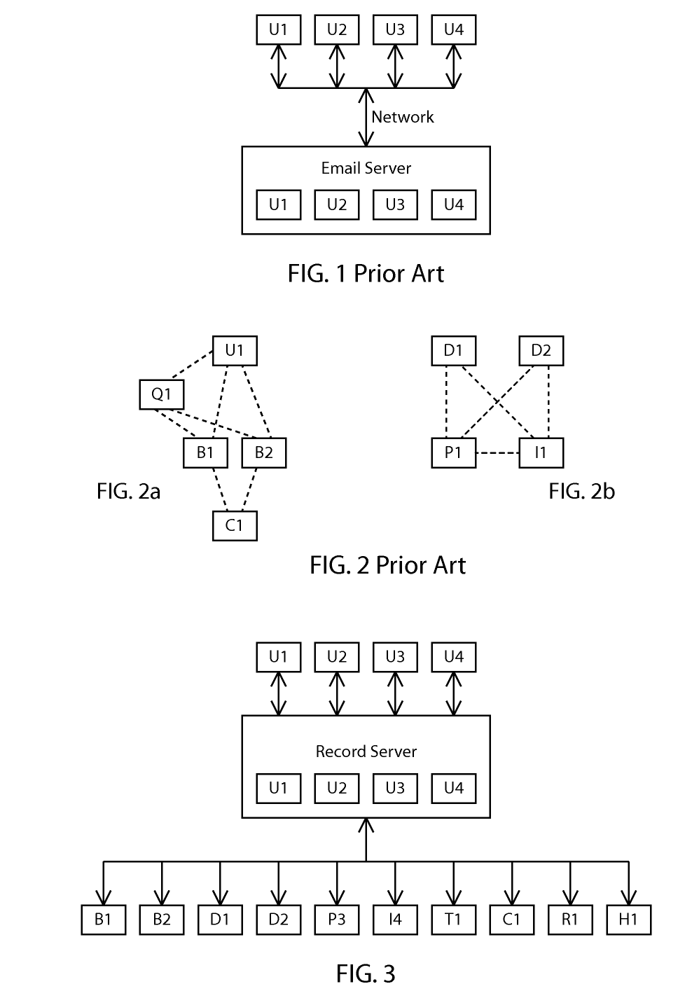

### DETAILED DESCRIPTION OF THE INVENTION

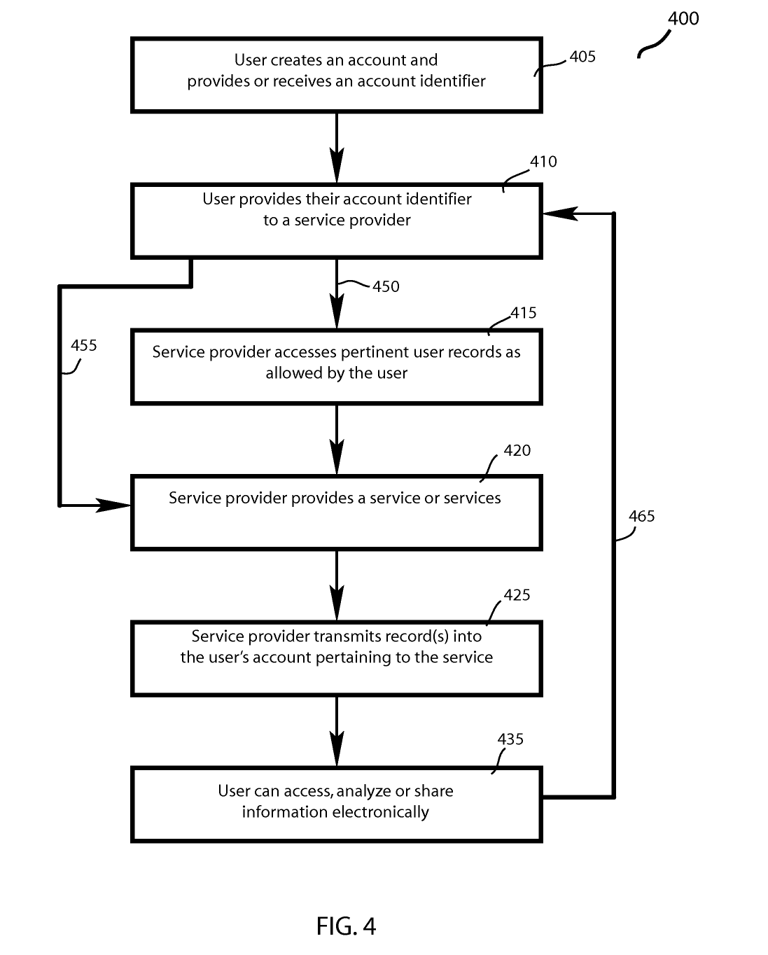

FIG. 4 provides an exemplary embodiment of the invention. In a first step 405, a user, or their guardian, creates an account and provides or receives an account identifier. The account identifier may be provided as an account number by a record storage service provider. For privacy and security purposes the account identifier may be provided on an electronic card bearing encryption methods.

In a second step 410, the user provides their account identifier to a health practitioner, financial institution, retailer, etc. In a third, and optional step 415, the user may permit access to specific portions of their records such that the service provider may access pertinent records prior to performing a service. For example, a second doctor may review tests and a diagnosis provided by a first doctor. Similarly, information required for a loan application may be drawn from the user's database.

In a forth step 420, the service provider provides a service, performs a test, provides a diagnosis, accepts a deposit, closes a sale, etc.

In a fifth step 425, the service provider utilizes the user's account identifier to insert a record into the database to document the services provided within the transaction processed. The record may include the results of an examination, blood test results, images, diagnosis, treatments, payments, products purchased, warranty information, etc.

In a sixth step 430, the user may access their records through their record storage account. At the user's discretion, they may provide their account identifier to another service provider, thus 465 repeating the process from second step 410.

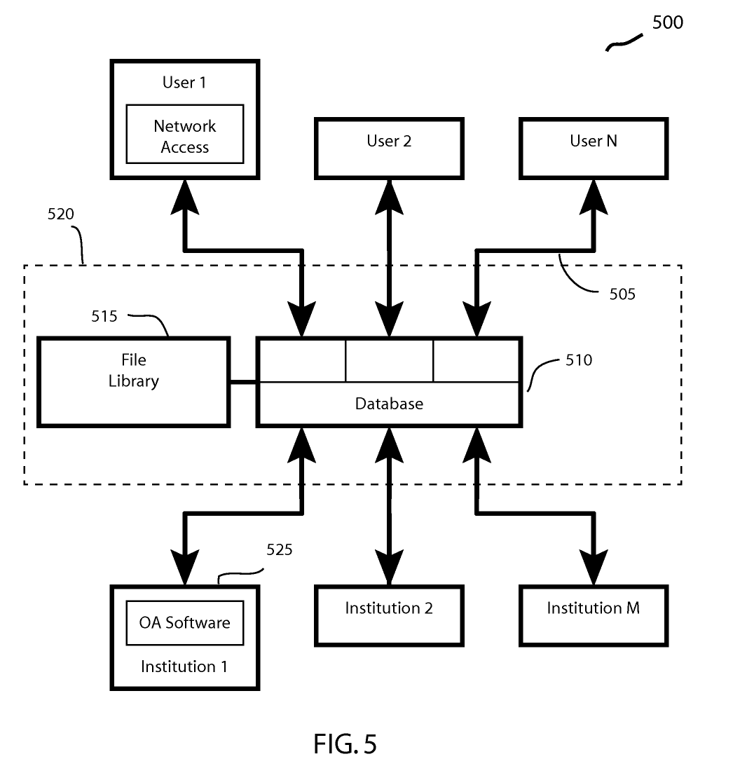

FIG. 5 provides a block diagram of an embodiment of the invention implementing the method of FIG. 4. More specifically, a database provider 520 maintains a database 510, a file library 515 and provides network access 505 to users and institutions via a network interface. Thus, from a computer, a user may create an account in the record storage database for themselves or for a person whom they are an advisor or legal guardian for. Once an account has been established, the user receives an account identifier such as an account number and/or an identification card. At the time of opening a new account with an institution including private practitioners, the user provides their account identifier, so that the service provider can transport current and future transactions systematically to the user's record storage database.

Service providers and their institutions 525 normally utilize office automation software (OAS) to record a user's personal information as well as transaction records. As offices become “paperless”, meaning that all information is recorded via computer at the time of service, the information is readily available for transmission to a user oriented database. Thus, office automation software may implement aspects of the invention wherein resultant information, pursuant to a transaction, is assembled into a record and transported to a destination specified by the user. Office automation software, according to the invention, can access the user's account and insert records into the database through remote procedure calls (RPC), file transfer protocol (FTP) or other network protocol. Once a record is inserted into the database, the user can access the data, use and/or share the information. Likewise, according to the user, office automation software may transport records from the user's record storage provider as allowed by the user.

With accessible records on a network, various software applications, including mobile communication applications, may access the user's records to provide useful information services. For example, the user may receive test results on their mobile communications device or the user may show a service provider images or the visual output from a mobile application.

It is recognized that records, and their transport, must be secure and privacy maintained. To facilitate secure record transport, commonly available encryption methods may be employed. For example, the user may have a master encryption key for managing their account. The user's account identifier may comprise a second encryption key that, when given to a service provider, enables a service provider to insert records into the user's database or access records from the database.

Once user information has been entered into the user's database and transport channels established between service providers and record storage providers, the user may share information. For example, the user may grant access rights to specific information or request a transfer of information to additional parties.

The database provider may provide many services to assist the user with managing their personal information. For example, as records accumulate over time, a medically oriented application can provide the user and their current doctor with emerging trends in the health of a user. For example, changes in blood chemistry or blood pressure can be analysed; charted and presented that indicates changes in the user's health over a period of years. The database provider may also supply nutritional information for those people seeking to manage day to day personal health issues such as body weight, blood pressure and cholesterol level. If a health provider or dietician provides a strict diet, the database provider can offer meal plans and suggestions, and provide a means for the user to record consumption and calculate nutritional information to be fed back to the user's doctor or dietician.

The database provider may also provide patients with a variety of information about doctors. For example, when a patient is diagnosed with a condition, the database provider can offer links to specialists the field, their credentials, success rates and popularity with their patients.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. A method comprising; systematically and electronically transferring, according to a first party, records to a destination defined by said first party.

2. The method of claim 1, wherein said record comprises ownership of said first party.

3. The method of claim 1, wherein said destination comprises a record storage location bearing ownership of said first party.

4. The method of claim 1, said transferring comprising; preparing said record according to a transaction pertaining to said first party and transmitting said record to said destination.

5. The method of claim 1, wherein said record is encrypted according to an encryption key according to said first party.

6. The method of claim 1, said transferring comprising; said destination receiving said record according to a transaction pertaining to said first party and storing information according to said record and said first party.

7. The method of claim 6 said transferring further comprising, providing notification to said first party.

8. A method for a second party to access information according to a first party comprising; accessing a record storage area bearing ownership of said first party, wherein said accessing comprises at least one of reading or writing information according to said first party.

9. The method of claim 8, wherein said second party systematically writes information to said record storage area according to transactions pertaining to said first party.

10. The method of claim 8, wherein said second party comprises at least one of: medical, dental, laboratory, financial, retail, dining, travel, insurance and civil institutions.

11. The method of claim 8 further comprising; providing said first party with access control of said record storage area, wherein said access control comprises at least one of: granting read, write, familial, next of kin, legal guardian, emergency and restricted access to said record storage area by a third party.

12. The method of claim 8 further comprising; compiling said information into reports according to said information.

13. The method of claim 8 further comprising; providing recommendations according to said information.

14. The method of claim 8, wherein said confidential personal information comprises at least one of the set: images, videos, measurements, test results, financial transactions, medical records, medical images, dental records, optical records, familial information, names, dates, times and historical data.

15. The method of claim 8, wherein said second party accesses a plurality of said record storage area bearing respective ownership of a plurality of said first party.

16. The method of claim 8, further comprising a plurality of said record storage areas according to a plurality of said first party.

17. The method of claim 16, wherein said application software compiles reports according to said plurality of said record storage areas.

18. Application software comprising; storing first party account details according to a record storage area bearing ownership of a first party and accessing said record storage area wherein said accessing comprises at least one of reading or writing information according to said first party.

19. The application software of claim 18, wherein said confidential personal information comprises at least one of the set: images, videos, measurements, test results, financial transactions, medical records, medical images, dental records, optical records, familial information, names, dates, times and historical data.

20. The application software of claim 18, wherein said application software comprises at least one of the set; office automation software, financial software, personal finance software, mobile application software, analytical software for processing said information and hosting software for providing said first party with access to said information.

21. The application software of claim 18, further comprising a plurality of said first party account details according to a plurality of said first party.

22. The application software of claim 18, further comprising a plurality of said record storage areas according to a plurality of said first party.

23. The application software of claim 22, wherein said application software compiles reports according to said plurality of said record storage areas.
